(19) United States
(12) Patent Application Publication
(10) Pub. No.: US 2025/0306529 A1
(43) Pub. Date: Oct. 2, 2025

(54) CARTRIDGE AND IMAGE FORMING APPARATUS

(71) Applicant: CANON KABUSHIKI KAISHA, Tokyo (JP)

(72) Inventors: TAKATOSHI HAMADA, Shizuoka (JP); HIROKI SHIMIZU, Shizuoka (JP); YUSUKE ATSU, Kanagawa (JP)

(21) Appl. No.: 19/090,695

(22) Filed: Mar. 26, 2025

(30) Foreign Application Priority Data
Mar. 29, 2024 (JP) 2024-057812

(51) Int. Cl. G03G 21/18

(52) U.S. Cl. CPC G03G 21/1821; G03G 21/1814

(57) ABSTRACT

A cartridge includes: a first unit; a second unit which is configured to be swingable with respect to the first unit between a contact position and a separation position; a rotating member which is rotatable to a first position for holding the second unit at the separation position, a second position for holding the second unit at the contact position, and a third position further rotated in a first rotating direction from the second position; and a pressing member which is configured to be capable of pressing the rotating member in the first rotating direction and which includes a first surface that comes into contact with the rotating member at the first position and a second surface that is depressed with respect to the first surface, the second surface being capable of coming into contact with the rotating member when the rotating member is positioned at the third position.

### BACKGROUND OF THE INVENTION

### Field of the Invention

The present invention relates to a cartridge and to an image forming apparatus equipped with a cartridge.

### Description of the Related Art

As image forming apparatuses, those which perform a developing process in a state where a developing member is in contact with a photosensitive drum are known. In such image forming apparatuses, the photosensitive drum and the developing member are sometimes configured so as to be capable of separating from each other. Japanese Patent Application Laid-open No. 2020-154312 discloses a configuration including: a holding member for holding a photosensitive drum and a developing member in a state of being in contact with each other and in a state of being separated from each other; and a contact force receiving member which receives a force from an apparatus main body and moves the holding member.

### SUMMARY OF THE INVENTION

An object of the present invention is to further develop conventional configurations.

In order to achieve the object described above, a cartridge according to the present invention includes:
a first unit including a photosensitive member;
a second unit including a developing member which develops an electrostatic latent image formed on the photosensitive member, the second unit being configured to be swingable with respect to the first unit between a contact position where the developing member comes into contact with the photosensitive member and a separation position where the developing member separates from the photosensitive member;
a rotating member configured to be rotatable to a first position, a second position, and a third position, the first position being a position for holding the second unit at the separation position against a biasing force which biases the second unit at the separation position toward the contact position, the second position being a position for holding the second unit at the contact position and being a position rotated in a first rotating direction from the first position, and the third position being a position further rotated in the first rotating direction from the second position; and
a pressing member configured to be capable of pressing the rotating member in the first rotating direction, the pressing member includes a first surface which comes into contact with the rotating member at the first position and a second surface which is depressed in an opposite direction to a direction faced by the first surface with respect to the first surface and which can come into contact with the rotating member in a case where the rotating member is positioned at the third position.

The present invention can further develop conventional configurations.

Further features of the present invention will become apparent from the following description of exemplary embodiments with reference to the attached drawings.

### BRIEF DESCRIPTION OF THE DRAWINGS

FIGS. 1A and 1B are explanatory diagrams of a switching configuration of an engagement position between a holding member and a force receiving member;

FIG. 2 is a schematic sectional view of an image forming apparatus;

FIG. 3 is a sectional view of a process cartridge;

FIG. 4 is a sectional view of the image forming apparatus in a state where a front door is open;

FIG. 5 is a sectional view of the image forming apparatus in a state where a tray is positioned outside an apparatus main body;

FIG. 6 is a sectional view of the image forming apparatus from which a process cartridge has been removed;

FIG. 7 is an exploded perspective view of a drum unit;

FIG. 8 is an exploded perspective view of a developing unit;

FIG. 9 is a perspective assembly diagram of the process cartridge;

FIG. 10 is a perspective view of the process cartridge;

FIGS. 11A and 11B are perspective views showing a configuration of a developing contact/separation mechanism;

FIGS. 12A to 12D are explanatory diagrams of a contacting/separating operation of a photosensitive drum and a developing roller;

FIGS. 13A to 13D are explanatory diagrams of a force applying member;

FIGS. 14A and 14B are explanatory diagrams of a developing contact suppression configuration;

FIG. 15 is an explanatory diagram of an arrangement relationship between a projected portion and a force receiving member; and

FIG. 16 is an explanatory diagram of an arrangement position of the projected portion.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

First, an image forming apparatus according to the present invention will be described. In this case, an image forming apparatus refers to an apparatus that forms an image on a recording medium using various known image forming principles or systems such as an electrophotographic process, an electrostatic recording process, and a magnetic recording process. Examples include copiers, printers (for example, laser printers and LED printers), facsimile machines, word processors, and image display apparatuses (electronic black boards and electronic white boards). A recording medium is a medium on which an image is formed by an image forming apparatus and examples include paper, an OHT sheet, and an image display entity.

### First Embodiment

### Schematic Configuration of Image Forming Apparatus

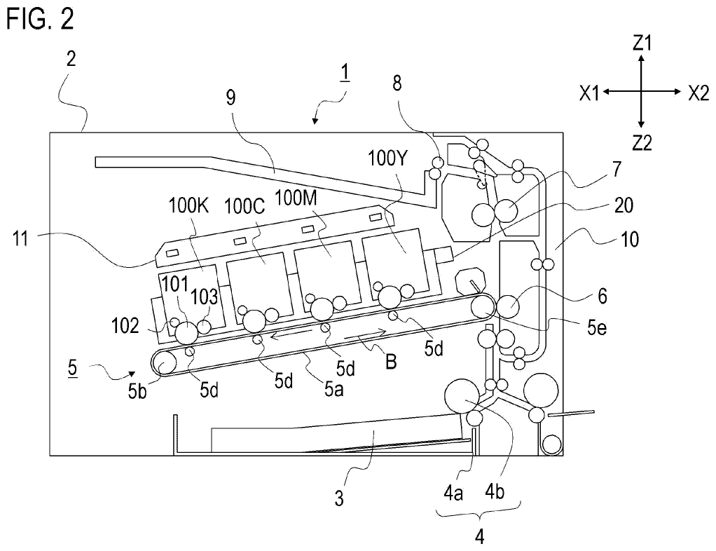

An electrophotographic image forming apparatus 1 (hereinafter, referred to as an image forming apparatus 1) according to a first embodiment will be described with reference to FIG. 2. FIG. 2 is a schematic sectional view showing an overall configuration of the image forming apparatus 1. The image forming apparatus 1 is a color laser beam printer adopting an electrophotographic system which forms images on a sheet-like recording medium 3.

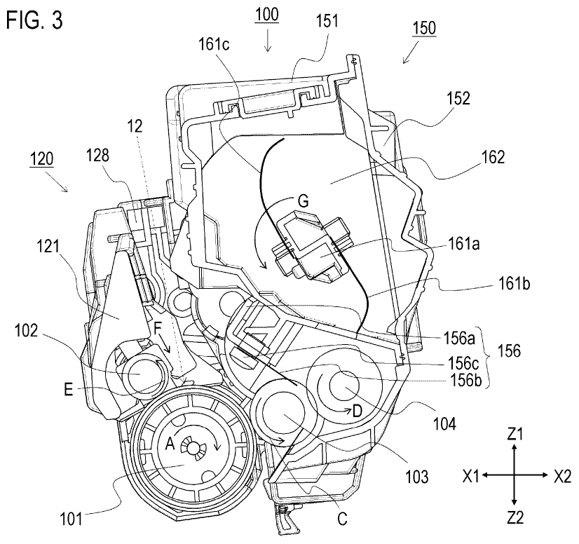

The image forming apparatus 1 is a four-color full-color laser beam printer using an electrophotographic process which forms a color image on the recording medium 3. The image forming apparatus 1 adopts a process cartridge system configured with an attachable/detachable cartridge. A process cartridge 100 is detachably mounted to an apparatus main body 2 of the image forming apparatus 1 and the image forming apparatus 1 forms a color image on the recording medium 3. FIG. 3 is a sectional view of the process cartridge 100. An opening for putting the process cartridge 100 into the apparatus main body 2 and taking the process cartridge 100 out from the apparatus main body 2 is formed in the apparatus main body 2. In addition, the apparatus main body 2 includes a front door 10 as an opening/closing member for opening and closing the opening.

In the following description, with respect to the image forming apparatus 1, a front side refers to a side where the front door 10 is arranged. A rear side refers to an opposite side to the front side. A front-back direction refers to a direction (forward direction) from the rear side toward the front side of the image forming apparatus 1 and to an opposite direction (rearward direction) thereof. Left and right refer to left and right when the image forming apparatus 1 is viewed from the front side. A left-right direction refers to a direction (leftward direction) from left to right and to an opposite direction (rightward direction) thereof. Up and down refer to up and down in a direction of gravitational force (vertical direction). An upward direction refers to a direction from down to up and a downward direction refers to a direction from up to down. FIG. 2 is a diagram in which the image forming apparatus 1 is viewed in the rightward direction with the upward direction shown as a Z1 direction, the downward direction as a Z2 direction, the rearward direction as an X1 direction, and the forward direction as an X2 direction. In addition, FIG. 3 shows the process cartridge 100 in a posture of being mounted to the apparatus main body 2.

When viewing the image forming apparatus 1 from the front, a right side is a driven side and a left side is a non-driven side of the image forming apparatus 1 (process cartridge 100). In other words, FIG. 2 is a sectional view of the image forming apparatus 1 as viewed from the non-driven side, with a near side of a paper surface being the non-driven side of the image forming apparatus 1 and a far side of the paper surface being the driven side of the image forming apparatus 1. The driven side of the process cartridge 100 is a side where a drum coupling member (photosensitive member coupling member) to be described later is arranged when viewed in an axial direction of a photosensitive drum and a side where a developing coupling member to be described later is arranged when viewed in an axial direction of a developing roller (developing member).

First to fourth process cartridges 100 (100Y, 100M, 100C, and 100K) are arranged approximately in a horizontal direction in the apparatus main body 2 of the image forming apparatus 1. Each of the first to fourth process cartridges 100 (100Y, 100M, 100C, and 100K) has a similar electrophotographic process mechanism but differ in color and fill amount of a developer (hereinafter, referred to as toner). Therefore, unless the image forming sections need to be particularly distinguished from each other in the following description, the image forming sections will be generally described by omitting the suffixes Y to K.

The process cartridge 100 receives a rotational drive force from a drive output portion (details will be described later) provided in the apparatus main body 2 and the process cartridge 100 is supplied bias voltages (charging bias, developing bias, electrostatic residual detection bias, and the like) from contacts (not illustrated) in the apparatus main body 2.

As shown in FIG. 3, the process cartridge 100 according to the first embodiment includes a drum unit 120 (first unit) equipped with a photosensitive drum 101 and charging means as processing means that acts on the photosensitive drum 101. In some cases, the drum unit 120 includes not only the charging means but also cleaning means as processing means.

In addition, the process cartridge 100 includes a developing unit 150 (second unit) equipped with developing means that develops an electrostatic latent image on the photosensitive drum 101. For example, the developing means includes a developing roller 103 that is a developing member for supplying a toner to the photosensitive drum 101. The drum unit 120 and the developing unit 150 are coupled to each other. In addition, the photosensitive drum 101 and the developing roller 103 are configured to be capable of coming into contact with each other and separating from each other. In a state where the process cartridge 100 is not mounted to the apparatus main body 2 or a state where a developing process is not being performed, deformation of an elastic layer of the developing roller 103 and unnecessary adherence of toner to the photosensitive drum 101 can be suppressed by having the photosensitive drum 101 and the developing roller 103 separate from each other. A more specific configuration of the process cartridge 100 will be described later.

The first process cartridge 100Y houses yellow (Y) toner in a developing frame body and forms a yellow toner image on a surface of the photosensitive drum 101. The second process cartridge 100M houses magenta (M) toner in a developing frame body and forms a magenta toner image on the surface of the photosensitive drum 101. The third process cartridge 100C houses cyan (C) toner in a developing frame body and forms a cyan toner image on the surface of the photosensitive drum 101. The fourth process cartridge 100K houses black (K) toner in a developing frame body and forms a black toner image on the surface of the photosensitive drum 101.

A laser scanner unit 11 as exposing means is provided above the first to fourth process cartridges 100. The laser scanner unit 11 outputs laser light 12 in correspondence with image information. In addition, the laser light 12 passes through an exposure window 128 of the process cartridge 100 and scans and exposes the surface of the photosensitive drum 101.

An intermediate transfer unit 5 as a transfer member is provided below the first to fourth process cartridges 100. The intermediate transfer unit 5 includes a driver roller 5e, a tension roller 5b, and a flexible transfer belt 5a. The transfer belt 5a is stretched between the driver roller 5e and the tension roller 5b.

A lower surface of the photosensitive drum 101 of each process cartridge 100 is in contact with an upper surface of the transfer belt 5a. In addition, a primary transfer roller 5d is provided so as to oppose the photosensitive drum 101 on an inner side of the transfer belt 5a. A contact portion between the photosensitive drum 101 and the transfer belt 5a is a primary transfer portion where a toner image is transferred from the photosensitive drum 101 to the transfer belt 5a. The primary transfer portion can also be described as a portion where the photosensitive drum 101 and the primary transfer roller 5d are in contact with each other via the transfer belt 5a.

A secondary transfer roller 6 is in contact with the driver roller 5e via the transfer belt 5a. A contact portion between the transfer belt 5a and the secondary transfer roller 6 is a secondary transfer portion where a toner image is transferred from the transfer belt 5a to the recording medium 3. The secondary transfer portion can also be described as a portion where the driver roller 5e and the secondary transfer roller 6 are in contact with each other via the transfer belt 5a.

A paper feeding unit 4 is provided below the intermediate transfer unit 5. The paper feeding unit 4 includes a paper feeding tray 4a which houses the recording medium 3 in a stacked state and a paper feeding roller 4b which conveys the recording medium 3 from the paper feeding tray 4a.

A fixing apparatus 7 and a paper discharging apparatus 8 are provided on a front side and an upper side (upper right in FIG. 2) inside the apparatus main body 2. In addition, a paper discharge tray 9 is formed on an upper surface of the apparatus main body 2. A toner image is fixed to the recording medium 3 by fixing means provided in the fixing apparatus 7 and, subsequently, the recording medium 3 is discharged to the paper discharge tray 9.

### Image Forming Operation

Next, an image forming operation for forming a full-color image by the image forming apparatus 1 will be described. A control portion of the image forming apparatus 1 starts an image forming operation to the recording medium 3 based on an image signal received from an external host apparatus. For example, the external host apparatus is a personal computer, an image reader, or a facsimile machine.

During an image forming operation, the photosensitive drum 101 of each of the first to fourth process cartridges 100 is rotationally driven in a direction of an arrow A in FIG. 3 at a prescribed speed. In addition, the transfer belt 5a is rotationally driven in a speed corresponding to the speed of the photosensitive drum 101 in a forward direction (a direction of an arrow B in FIG. 2) with respect to the rotation of the photosensitive drum 101.

The laser scanner unit 11 scans and exposes the surface of each photosensitive drum 101 with the laser light 12 in accordance with an image signal of each color. In addition, in synchronization with the drive of the laser scanner unit 11, a charging roller 102 uniformly charges the surface of the photosensitive drum 101 to a prescribed polarity and potential in each process cartridge 100. Accordingly, an electrostatic latent image in accordance with an image signal of a corresponding color is formed on the surface of each photosensitive drum 101. The formed electrostatic latent image is developed by the developing roller 103 which is rotationally driven at a prescribed speed in the forward direction (a direction of an arrow C in FIG. 3) with respect to the rotation of the photosensitive drum 101.

Due to the electrophotographic image forming process operation described above, a yellow toner image corresponding to a yellow component of a full-color image is formed on the photosensitive drum 101 of the first process cartridge 100Y. In addition, the toner image is primarily transferred onto the transfer belt 5a.

In a similar manner, a magenta toner image corresponding to a magenta component of a full-color image is formed on the photosensitive drum 101 of the second process cartridge 100M. In addition, the toner image is primarily transferred so as to be superimposed on the yellow toner image that has already been transferred onto the transfer belt 5a.

In a similar manner, a cyan toner image corresponding to a cyan component of a full-color image is formed on the photosensitive drum 101 of the third process cartridge 100C. In addition, the toner image is primarily transferred so as to be superimposed on the yellow and magenta toner images that have already been transferred onto the transfer belt 5a.

In a similar manner, a black toner image corresponding to a black component of a full-color image is formed on the photosensitive drum 101 of the fourth process cartridge 100K. In addition, the toner image is primarily transferred so as to be superimposed on the yellow, magenta, and cyan toner images that have already been transferred onto the transfer belt 5a.

In this manner, an unfixed full-color toner image in the four colors of yellow, magenta, cyan, and black is formed on the transfer belt 5a.

On the other hand, the recording medium 3 is separated and fed one sheet at a time from the paper feeding unit 4 at a prescribed control timing. The recording medium 3 is introduced to the secondary transfer portion which is a contact region between the secondary transfer roller 6 and the transfer belt 5a at a prescribed control timing. In addition, the four-color superimposed toner image on the transfer belt 5a is sequentially transferred en masse to the surface of the recording medium 3 in the conveying process of the recording medium 3 to the secondary transfer portion.

### Outline of Process Cartridge Attachment/Detachment Configuration

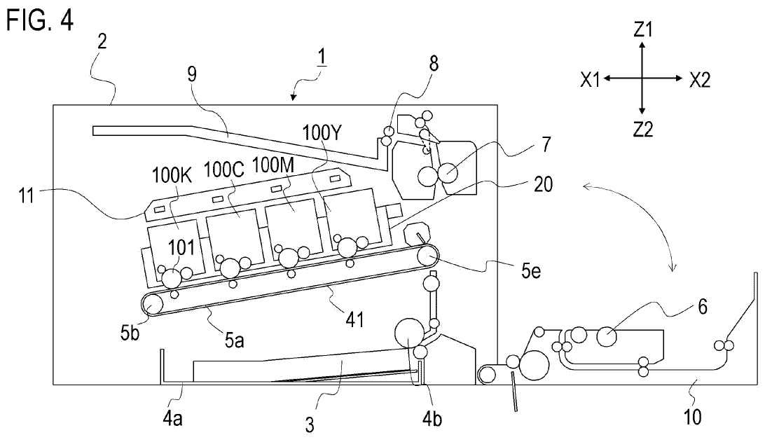

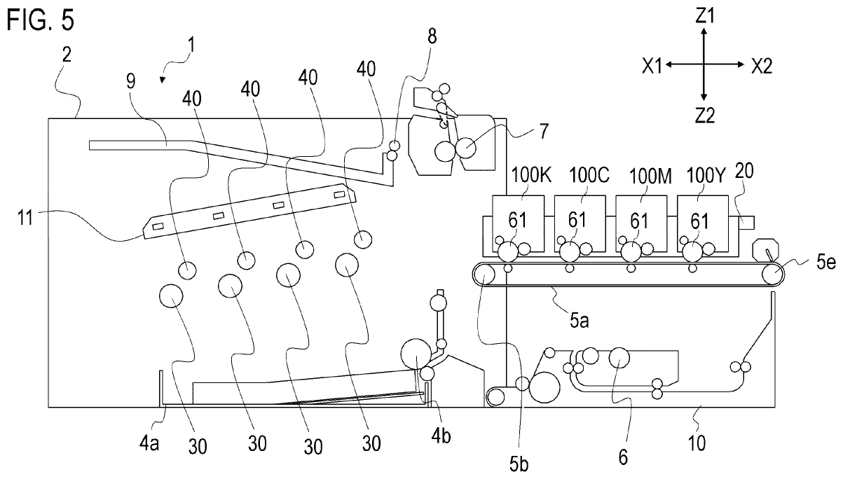

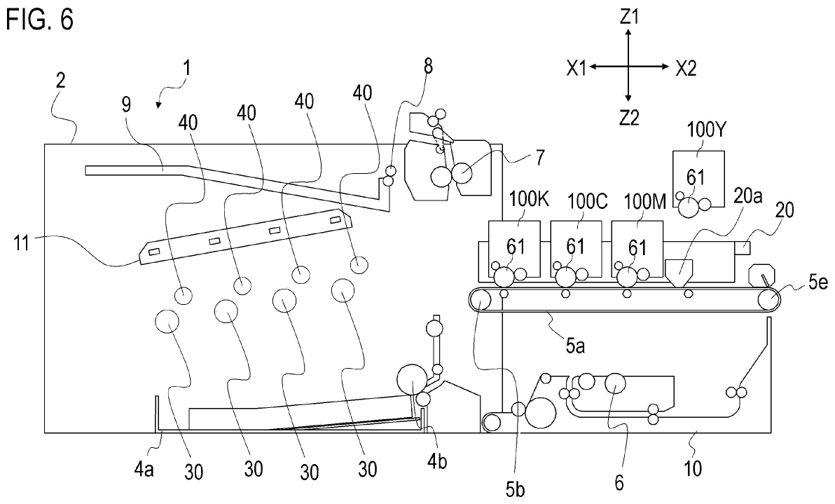

A cartridge tray 20 (hereinafter, referred to as a tray 20) which supports the process cartridge 100 will be described in further detail with reference to FIGS. 4 to 6. FIG. 4 is a sectional view of the image forming apparatus 1 in a state where the tray 20 is positioned inside the apparatus main body 2 and the front door 10 is open. FIG. 5 is a sectional view of the image forming apparatus 1 in a state where the tray 20 is positioned outside the apparatus main body 2, the process cartridge 100 is housed inside the tray 20, and the front door 10 is open. FIG. 6 is a sectional view of the image forming apparatus 1 in a state where the tray 20 is positioned outside the apparatus main body 2, the first process cartridge 100Y has been removed from the tray 20, and the front door 10 is open.

As shown in FIGS. 4 and 5, the tray 20 is configured to be capable of moving in a direction of an arrow X1 (a push-in direction) and a direction of an arrow X2 (a pull-out direction) which are substantially horizontal directions with respect to the apparatus main body 2. In other words, the tray 20 is provided so that the tray 20 can be pulled out from and pushed into the apparatus main body 2 and configured to be movable in an approximately horizontal direction in a state where the image forming apparatus 1 is installed on a horizontal surface. Hereinafter, a position of the tray 20 positioned inside the apparatus main body 2 in a state where the front door 10 is open will be referred to as an inside position and a state of the tray 20 will be referred to as an inside state. In addition, a position of the tray 20 positioned outside the apparatus main body 2 in a state where the front door 10 is open will be referred to as an outside position and a state of the tray 20 will be referred to as an outside state. FIG. 4 shows a situation where the tray 20 is at the inside position and in the inside state and FIG. 5 shows a situation where the tray 20 is at the outside position and in the outside state. When the tray 20 is in the inside state or the outside state, the photosensitive drum 101 and the transfer belt 5a are separated from each other.

The tray 20 includes a mounting portion 20a to which the first process cartridge 100Y is detachably mounted. In a similar manner the tray 20 includes mounting portions 20a to which the second process cartridge 100M, the third process cartridge 100C, and the fourth process cartridge 100K are detachably mounted, respectively. As shown in FIG. 6, the process cartridge 100 can be attached to and detached from the mounting portion 20a of the tray 20 at the outside position. In addition, the process cartridge 100 moves between the inside and the outside of the apparatus main body 2 together with the tray 20 in a state of being arranged at the mounting portion 20a.

In the first embodiment, by closing the front door 10, the intermediate transfer unit 5 is raised in a direction of an arrow Z1 by a linking mechanism (not illustrated) and is moved to an image formation-time position (a position where the photosensitive drum 101 and the transfer belt 5a come into contact with each other). In addition, by opening the front door 10, the intermediate transfer unit 5 is lowered in a direction of an arrow Z2 and the photosensitive drum 101 and the transfer belt 5a separate from each other.

As described above, due to the tray 20, the plurality of process cartridges 100 can be collectively moved to a position inside the apparatus main body 2 where image formation can be performed and collectively pulled outside of the apparatus main body 2.

### Overall Configuration of Process Cartridge

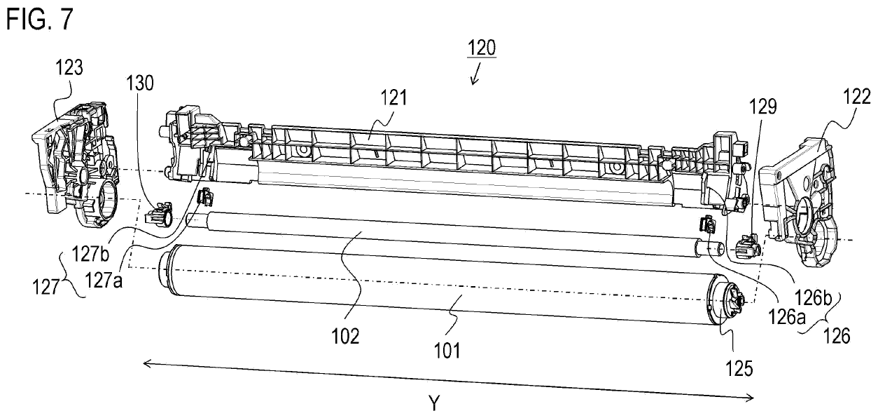

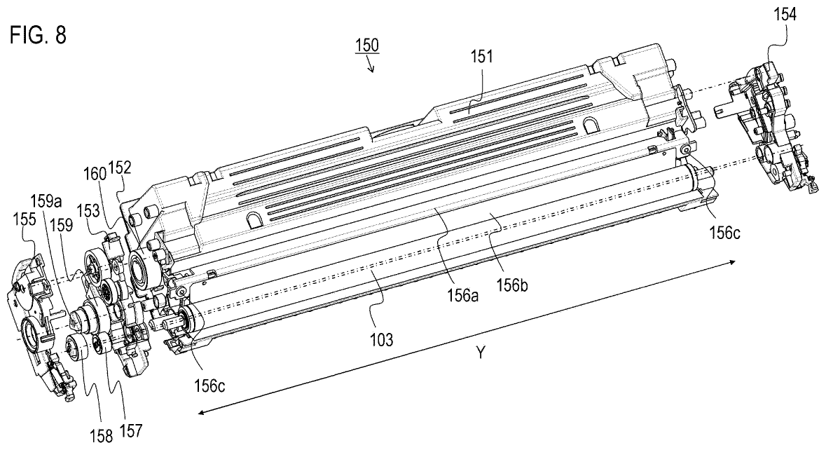

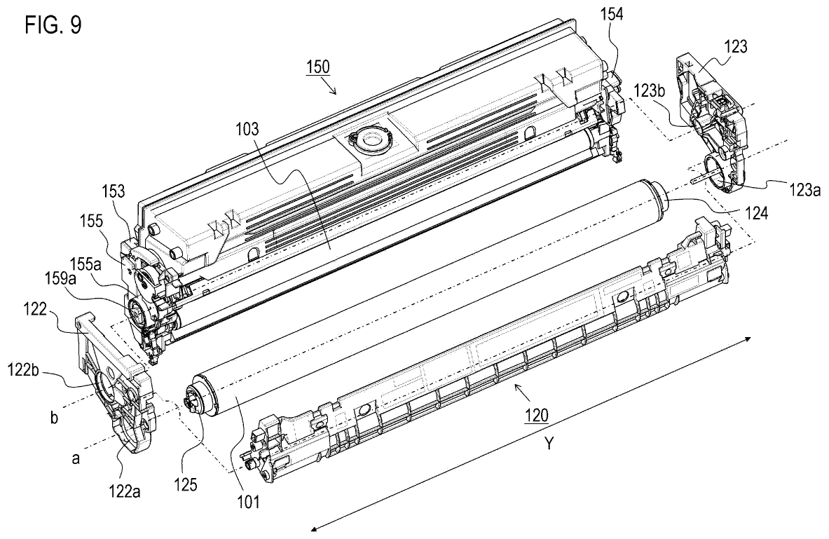

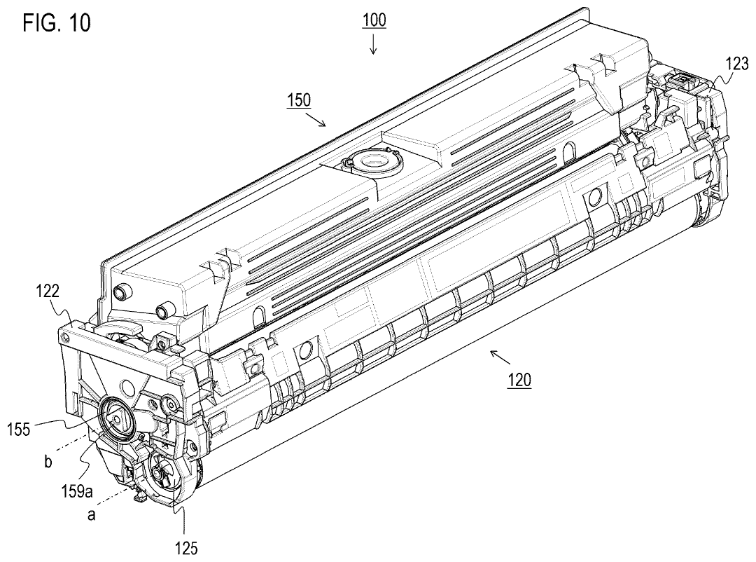

Next, a configuration of the process cartridge 100 will be described in more detail with reference to FIGS. 7 to 10. FIG. 7 is an exploded perspective view of the drum unit 120. FIG. 8 is an exploded perspective view of the developing unit 150. FIG. 9 is a perspective assembly diagram of the process cartridge 100 as viewed from a driven side that is a side of one end in an axial direction of the photosensitive drum 101. FIG. 10 is a perspective view of the process cartridge 100 as viewed from the driven side.

The process cartridge 100 is equipped with the photosensitive drum 101 and processing means that acts on the photosensitive drum 101. In this case, the processing means includes the charging roller 102 as charging means which charges the photosensitive drum 101 and the developing roller 103 as developing means which develops latent images formed on the photosensitive drum 101. The process cartridge 100 is constituted of the drum unit 120 as the first unit and the developing unit 150 as the second unit.

In the following description, a longitudinal direction Y of the drum unit 120 and the developing unit 150 is a direction that is approximately parallel to a rotational axis a of the photosensitive drum 101 shown in FIG. 9. In addition, the longitudinal direction Y is approximately parallel to the left-right direction of the image forming apparatus 1 in a state where the process cartridge 100 is mounted to the apparatus main body 2.

### Configuration of Drum Unit

Next, a detailed configuration of the drum unit 120 will be described. As shown in FIGS. 7 and 9, the drum unit 120 is constituted of the photosensitive drum 101, the charging roller 102, a drum frame body 121, and the like.

The drum unit 120 is equipped with a charging roller bearing unit 126 arranged at an end on the driven side of the charging roller 102 and a charging roller bearing unit 127 arranged at an end on the non-driven side of the charging roller 102. The bearing unit 126 includes a bearing 126a which rotatably supports the charging roller 102 and a pressure spring 126b which biases the charging roller 102 toward the photosensitive drum 101. In a similar manner, the bearing unit 127 includes a bearing 127a which rotatably supports the charging roller 102 and a pressure spring 127b which biases the charging roller 102 toward the photosensitive drum 101. Therefore, the charging roller 102 is rotatably supported by the bearings 126a and 127a and biased in a direction of an arrow F in FIG. 3 toward the photosensitive drum 101 by the pressure springs 126b and 127b.

In addition, a charging roller separation member 129 is attached to the end on the driven side of the charging roller 102 and a charging roller separation member 130 is attached to the end on the non-driven side of the charging roller 102. Due to these members, the charging roller 102 is separated from the photosensitive drum 101 in an initial factory state. In addition, the separation state is released when the photosensitive drum 101 rotates during use.

Furthermore, a cartridge cover member 122 is provided at an end on a driven side in the longitudinal direction of the process cartridge 100 and a cartridge cover member 123 is provided at an end on a non-driven side. The photosensitive drum 101 is rotatably supported by the cartridge cover members 122 and 123.

As shown in FIG. 9, a coupling member 125 for transmitting a driving force to the photosensitive drum 101 is provided on a side of one end (driven side) in the longitudinal direction of the photosensitive drum 101. The coupling member 125 couples with a drum drive coupling 30 as a drum drive output portion provided in the apparatus main body 2. A driving force of a drive motor (not illustrated) of the apparatus main body 2 is transmitted to the photosensitive drum 101 via the drum drive coupling 30 and the coupling member 125 and the photosensitive drum 101 is rotated in a direction of an arrow A in FIG. 3. In addition, a drum flange 124 is provided on a side of another end (non-driven side) in the longitudinal direction of the photosensitive drum 101. The bearing 126a and the bearing 127a which support the charging roller 102 are supported by the drum frame body 121 so that the charging roller 102 can come into contact with the photosensitive drum 101 and be driven to rotate (in a direction of an arrow E in FIG. 3).

### Configuration of Developing Unit

Next, a detailed configuration of the developing unit 150 will be described. As shown in FIGS. 3 and 8, the developing unit 150 is constituted of the developing roller 103, a toner transport roller 104, a developing blade 156, a developing frame body, and the like. The developing frame body includes a first developing frame body 151 and a second developing frame body 152. The first developing frame body 151 and the second developing frame body 152 are coupled to each other by ultrasonic welding or the like.

A toner housing portion 162 is formed in the developing frame body of the developing unit 150 as a space for housing toner to be supplied to the developing roller 103. In addition, the developing frame body is equipped with a bearing 153 provided on a driven side and a bearing 154 provided on a non-driven side with respect to the developing roller 103 and the toner transport roller 104. The developing frame body rotatably supports the developing roller 103 and the toner transport roller 104 and holds the developing blade 156 which restricts a layer thickness of toner on a circumferential surface of the developing roller 103 via the bearing 153 on the driven side and the bearing 154 on the non-driven side.

The developing blade 156 is, for example, an elastic member 156b being a sheet-like metal about 0.1 mm-thick, welded or otherwise attached to a supporting member 156a being a metallic material with an L-shaped cross section. The developing blade 156 is attached to the developing frame body by fixing screws 156c at two locations, one at one end and the other at the other end in the longitudinal direction.

A developing drive input gear 159 for transmitting a driving force to the developing unit 150 is provided on a side of one end (driven side) in the longitudinal direction of the developing unit 150. The developing drive input gear 159 is provided with a developing input coupling portion 159a which receives drive from a developing drive coupling 40 provided in the apparatus main body 2. Due to such a configuration, a driving force of a drive motor (not illustrated) of the apparatus main body 2 is input to the developing unit 150.

The driving force input to the developing unit 150 rotates the developing roller 103 in a direction of an arrow C in FIG. 3 by being transmitted to a developing roller gear 157 and rotates the toner transport roller 104 in a direction of an arrow D in FIG. 3 by being transmitted to a toner transport roller gear 158.

In addition, the developing unit 150 is equipped with a stirring member 161 arranged inside the toner housing portion 162 and a stirring gear 160 for driving the stirring member 161. Due to the driving force input to the developing unit 150 being transmitted to the stirring gear 160, the stirring member 161 is rotated in a direction of an arrow G in FIG. 3 and stirs the toner in the toner housing portion 162.

The stirring member 161 includes a rotating shaft 161a that is parallel to the rotational axis direction of the developing roller 103 and a first stirring sheet 161b and a second stirring sheet 161c as transporting members. The first stirring sheet 161b and the second stirring sheet 161c are flexible sheets. One end of the first stirring sheet 161b and one end of the second stirring sheet 161c are attached to the rotating shaft 161a and another end of the first stirring sheet 161b and another end of the second stirring sheet 161c are free ends. Due to the first stirring sheet 161b and the second stirring sheet 161c rotating with a rotation of the rotating shaft 161a, the toner in the toner housing portion 162 is stirred by the first stirring sheet 161b and the second stirring sheet 161c.

In addition, a developing cover member 155 which supports and covers the developing drive input gear 159 is provided on the side of one end (driven side) in the longitudinal direction of the developing unit 150.

### Engagement Configuration of Drum Unit and Developing Unit

An engagement configuration (assembly configuration) of the drum unit 120 and the developing unit 150 will be described with reference to FIG. 9. The drum unit 120 and the developing unit 150 are coupled by the cartridge cover member 122 provided at the end on the driven side in the longitudinal direction of the process cartridge 100 and the cartridge cover member 123 provided at the end on the non-driven side.

The cartridge cover member 122 on the driven side is provided with a developing unit supporting hole 122b for swingably (movably) supporting the developing unit 150 and a drum supporting hole 122a for rotatably supporting the photosensitive drum 101. In a similar manner, the cartridge cover member 123 on the non-driven side is provided with a developing unit supporting hole 123b for swingably (movably) supporting the developing unit 150 and a drum supporting hole 123a for rotatably supporting the photosensitive drum 101. In other words, the cartridge cover members 122 and 123 are supporting members which swingably support the developing unit 150 and rotatably support the photosensitive drum 101. In other words, due to the cartridge cover members 122 and 123, the developing unit 150 is supported so as to be swingable (movable) between a developing position where the developing roller 103 comes into contact with the photosensitive drum 101 and a separation position where the developing roller 103 separates from the photosensitive drum 101.

Upon engagement of the drum unit 120 and the developing unit 150, on one side (driven side), an outer diameter portion of a cylindrical portion 155a of the developing cover member 155 is fitted into the developing unit supporting hole 122b of the cartridge cover member 122. In addition, on the other side (non-driven side), an outer diameter portion of a cylindrical portion (not illustrated) of the bearing 154 is fitted into the developing unit supporting hole 123b of the cartridge cover member 123.

In addition, one end in the longitudinal direction of the photosensitive drum 101 is fitted into the drum supporting hole 122a of the cartridge cover member 122 and another end is fitted into the drum supporting hole 123a of the cartridge cover member 123. Furthermore, the cartridge cover member 122 and the cartridge cover member 123 are fixed to the drum unit 120 by screws, an adhesive, or the like which are not illustrated. Accordingly, the developing unit 150 is swingably supported by the cartridge cover members 122 and 123 with respect to the drum unit 120 (photosensitive drum 101) and can be positioned at a position where the developing roller 103 acts on the photosensitive drum 101 during image formation.

Due to the processes described above, the drum unit 120 and the developing unit 150 are assembled and integrally formed as the process cartridge 100. A state where the drum unit 120 and the developing unit 150 are assembled is shown in FIG. 10. FIG. 10 is a perspective view of the process cartridge 100.

Hereinafter, an axis line connecting the center of the developing unit supporting hole 122b of the cartridge cover member 122 on the driven side and the center of the developing unit supporting hole 123b of the cartridge cover member 123 on the non-driven side will be called the swing axis b. In this case, the cylindrical portion 155a of the developing cover member 155 provided at the end on the driven side of the process cartridge 100 is coaxial with the developing input coupling portion 159a. In other words, the developing unit 150 is configured so that a driving force is transmitted from the apparatus main body 2 by the swing axis b. In addition, the developing unit 150 is swingably supported around the swing axis b.

The developing unit 150 is configured so as to be swingable (movable) between a contact position where the developing roller 103 comes into contact with the photosensitive drum 101 and a separation position where the developing roller 103 separates from the photosensitive drum 101. In addition, the apparatus main body 2 is provided with a biasing configuration which biases the developing unit 150 in a direction from the separation position toward the contact position. For example, the biasing configuration includes a tension spring (not illustrated) which biases the developing unit 150 and the developing drive input gear 159 which applies a rotation torque to the developing unit 150.

### Configuration of Contact/Separation Mechanism

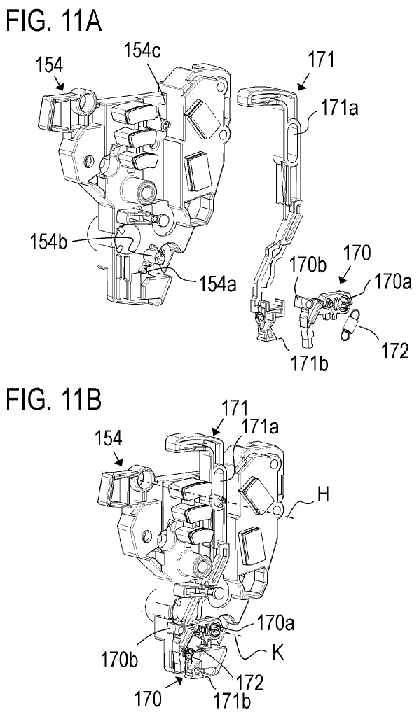

Next, a contact/separation mechanism which causes the photosensitive drum 101 of the process cartridge 100 and the developing roller 103 of the developing unit 150 to come into contact with and separate from each other will be described. The contact/separation mechanism assembled in the bearing 154 on the non-driven side which constitutes the developing frame body is shown in FIGS. 11A and 11B. FIGS. 11A and 11B are perspective views showing a configuration of the contact/separation mechanism. FIG. 11A shows a state before the contact/separation mechanism is assembled and FIG. 11B shows a state after the contact/separation mechanism is assembled. The contact/separation mechanism is constituted of a holding member 170, a force receiving member 171, and a tension spring 172.

The holding member 170 includes a supported portion 170a which is a hole with an approximately circular sectional shape. The supported portion 170a engages with a first supporting portion 154b provided on the bearing 154 on the non-driven side. The first supporting portion 154b is a projection that protrudes in the longitudinal direction of the developing unit 150. The holding member 170 is a rotating member (first rotating member) which is rotatably supported by the bearing 154 as the supported portion 170a engages with the first supporting portion 154b.

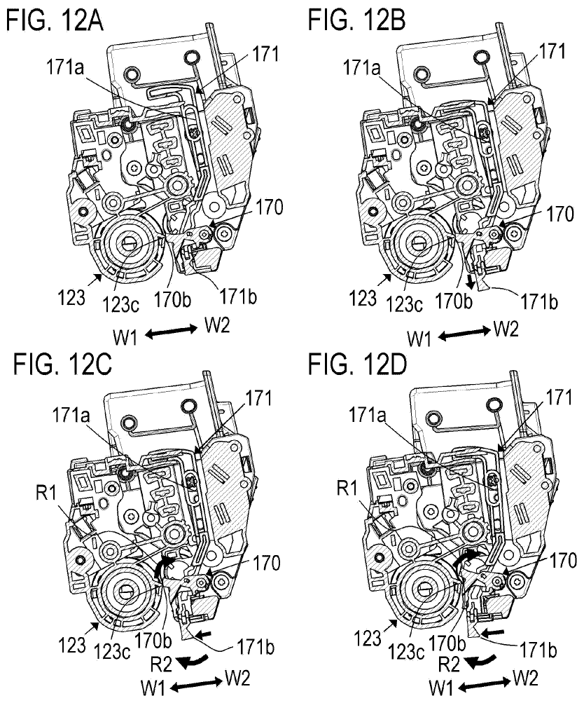

In addition, the holding member 170 includes a spacer member 170b (a spacer portion) which protrudes in a radial direction from the supported portion 170a. As shown in FIG. 12A, due to the spacer member 170b coming into contact with a contacted portion 123c of the cartridge cover member 123 on the non-driven side, the holding member 170 holds the developing separation state of the process cartridge 100.

The force receiving member 171 includes a supported portion 171a which is a slit with an oval sectional shape. The supported portion 171a engages with a second supporting portion 154c provided on the bearing 154. The second supporting portion 154c is a projection that protrudes in the longitudinal direction of the developing unit 150. The force receiving member 171 is a rotating member (second rotating member) which is translatably and rotatably supported by the bearing 154 as the supported portion 171a engages with the second supporting portion 154c. In a posture in which the process cartridge 100 is mounted to the apparatus main body 2, the supported portion 171a stretches in the up-down direction and the force receiving member 171 is movable up and down while maintaining its posture. In addition, the force receiving member 171 is configured to be rotatable when the force receiving member 171 is positioned in a lower part of its movable range or, in other words, when the second supporting portion 154c is positioned at an upper end of the supported portion 171a.

In addition, the force receiving member 171 includes a force receiving portion 171b which receives a force from a contact/separation control portion provided in the apparatus main body 2. The force receiving member 171 presses the holding member 170 so as to rotate the holding member 170 by receiving a force from the contact/separation control portion and rotating. In other words, the force receiving member 171 can also be described as a pressing member configured to be capable of pressing the holding member 170.

As shown in FIG. 11B, in a state where the process cartridge 100 is mounted to the apparatus main body 2, a rotation center H (rotation axis) of the force receiving member 171 is positioned above a rotation center K (rotation axis) of the holding member 170. In addition, a contact portion between the force receiving member 171 and the holding member 170 is positioned below the rotation center K and above the force receiving portion 171b. In other words, a distance from the contact portion to the rotation center H is greater than a distance from the contact portion to the rotation center K. Furthermore, a distance from the force receiving portion 171b to the rotation center H is greater than a distance from the contact portion to the rotation center H. Due to such a configuration, a force applied to the force receiving member 171 in order to rotate the holding member 170 can be reduced.

The tension spring 172 is a biasing member of which one end is fixed to the holding member 170 and another end is fixed to the force receiving member 171. The tension spring 172 exerts a biasing force in a direction to rotate the force receiving member 171 with respect to the holding member 170.

### Contacting/Separating Operation

A contacting/separating operation of the photosensitive drum 101 and the developing roller 103 by the contact/separation mechanism will be described in detail with reference to FIGS. 12A to 12D. FIGS. 12A to 12D are explanatory diagrams of the contacting/separating operation of the photosensitive drum 101 and the developing roller 103. FIGS. 12A to 12D are partial sectional views of the process cartridge 100 showing a contact state of the contacted portion 123c of the cartridge cover member 123 on the non-driven side and the spacer member 170b. FIGS. 12A to 12D show the process cartridge 100 in a posture of being mounted to the image forming apparatus 1.

FIG. 12A shows a situation where the process cartridge 100 is mounted to the apparatus main body 2 of the image forming apparatus 1 in a state where the front door 10 is open. In this state, the spacer member 170b of the holding member 170 is in contact with the contacted portion 123c of the cartridge cover member 123. In addition, the process cartridge 100 is in a developing separation state where the photosensitive drum 101 and the developing roller 103 are separated from each other. Due to the holding member 170 coming into contact with the cartridge cover member 123, the developing roller 103 is restricted from approaching the photosensitive drum 101 and the developing unit 150 (developing roller 103) is held at the separation position.

FIG. 12B shows a situation where the front door 10 of the image forming apparatus 1 has been closed from the state shown in FIG. 12A. When the front door 10 is closed, the force receiving member 171 is pressed from above by a linking mechanism which is driven in conjunction with a closing operation of the front door 10 and moves downward. The force receiving member 171 is biased upward by a biasing member (not illustrated) and the linking mechanism moves the force receiving member 171 downward against a biasing force of the biasing member. At this point, the force receiving member 171 moves so that the force receiving portion 171b that is an end on a lower side of the force receiving member 171 protrudes downward from the bearing 154 on the non-driven side. In this state, the spacer member 170b of the holding member 170 is in contact with the contacted portion 123c of the cartridge cover member 123. In addition, the process cartridge 100 is in a developing separation state where the photosensitive drum 101 and the developing roller 103 are separated from each other.

Even in the state in FIG. 12B, due to the holding member 170 coming into contact with the cartridge cover member 123, the developing unit 150 biased by the biasing configuration is restricted from moving from the separation position to the contact position. A position shown in FIG. 12B of the holding member 170 for holding the developing unit 150 so that the process cartridge 100 is in the developing separation state will be referred to as a first position.

FIG. 12C shows a situation where the force receiving portion 171b of the force receiving member 171 is pressed in a first direction W1 by the separation control portion provided in the apparatus main body 2 and starts to move. The first direction W1 is a direction in which the force receiving portion 171b approaches the cartridge cover member 123 and a direction which intersects with the rotational axis of the photosensitive drum 101 and the developing roller 103. In the state where the force receiving portion 171b is beginning to be pushed, the spacer member 170b of the holding member 170 is in contact with the contacted portion 123c of the cartridge cover member 123.

When the force receiving portion 171b receives a force in the first direction W1, the force receiving member 171 rotates. In addition, when the force receiving portion 171b rotates, the holding member 170 is pressed by the force receiving member 171 and rotates. Hereinafter, a direction in which the holding member 170 rotates when the force receiving portion 171b having received a force in the first direction W1 moves will be referred to as a first rotating direction R1. In addition, a direction in which the force receiving member 171 rotates when the force receiving portion 171b receives a force in the first direction W1 will be referred to as a second rotating direction R2.

FIG. 12D shows a situation where the force receiving member 171 further rotates in the second rotating direction R2 and the holding member 170 further rotates in the first rotating direction R1 from the state shown in FIG. 12C. When the holding member 170 rotates in the first rotating direction R1, the spacer member 170b of the holding member 170 moves upward. In addition, the spacer member 170b separates from the contacted portion 123c of the cartridge cover member 123.

When the holding member 170 separates from the cartridge cover member 123, the developing unit 150 is caused to swing from the separation position to the contact position so that the developing roller 103 approaches and comes into contact with the photosensitive drum 101. In other words, due to the release of the contact state between the spacer member 170b and the contacted portion 123c, the photosensitive drum 101 and the developing roller 103 come into contact with each other and the process cartridge 100 enters a developing contact state. In other words, due to a movement of the holding member 170 to a position where the holding member 170 separates from the cartridge cover member 123, the developing unit 150 is held at the contact position. A position shown in FIG. 12D for holding the developing unit 150 so that the process cartridge 100 enters the developing contact state will be referred to as a second position.

As described above, the holding member 170 is configured to be rotatable between the first position and the second position. In addition, the holding member 170 is configured to further rotate in the first rotating direction R1 from the second position to be rotatable to a third position. Details of the third position will be provided later. In addition, in the following description, a position of the force receiving member 171 shown in FIG. 12B will be referred to as a fourth position and a position of the force receiving member 171 shown in FIG. 12A will be referred to as a fifth position. In other words, the force receiving member 171 is configured to be translatable to the fourth position which is rotatable in the second rotating direction R2 and to the fifth position which is above the fourth position.

Due to the operation described above, the developing unit 150 moves from the separation position to the contact position and the process cartridge 100 makes a transition from the developing separation state to the developing contact state. When the process cartridge 100 is in the developing contact state, the image forming apparatus 1 is capable of performing an image forming operation.

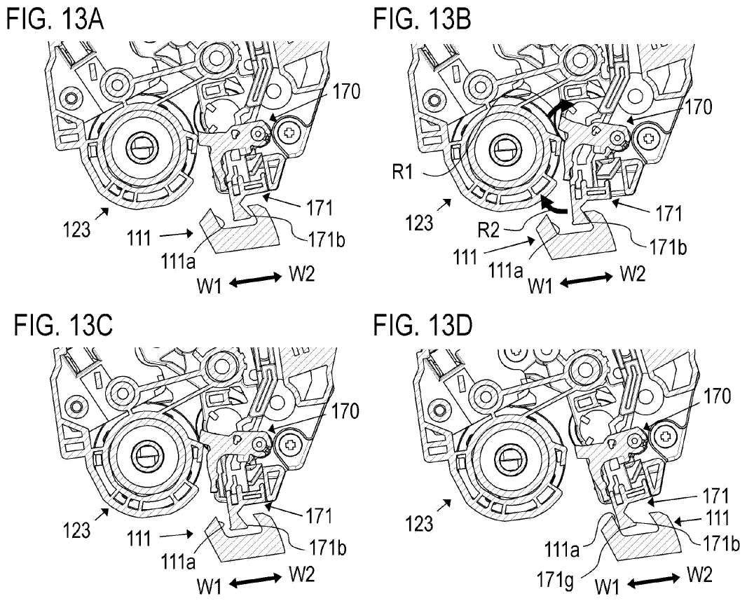

Next, a force applying member 111 of the contact/separation control portion which applies a force to the force receiving member 171 will be described. FIGS. 13A to 13D are explanatory diagrams of the force applying member 111. The force applying member 111 includes a force applying portion 111a which applies a force to the force receiving member 171 and is provided in the apparatus main body 2 so as to be movable in the first direction W1 and the second direction W2. The force applying portion 111a includes a surface facing the first direction W1 and a surface facing the second direction W2 and a cross section orthogonal to the rotation axis of the holding member 170 is formed in a U shape. When the force receiving member 171 is at the fourth position, a tip portion of the force receiving member 171 is positioned between the surface facing the first direction W1 and the surface facing the second direction W2 of the force applying member 111.

FIG. 13A shows a state where the holding member 170 at the first position comes into contact with the cartridge cover member 123 and the developing unit 150 is held at the separation position. In this case, a gap is provided between the force applying member 111 and the force receiving member 171. Due to the force applying member 111 moving in the first direction W1 from the state shown in FIG. 13A, the force applying portion 111a presses the force receiving portion 171b and the force receiving member 171 rotates in the second rotating direction R2. FIG. 13B shows a state where the force receiving member 171 is pressed by the force applying member 111 and rotates in the second rotating direction R2 and the holding member 170 is pressed by the force receiving member 171 and moves to the second position.

FIG. 13C shows a state where the force applying member 111 has moved in the second direction W2 from the state in FIG. 13B and has separated from the force receiving member 171. After the holding member 170 moves to the second position and separates from the cartridge cover member 123 and the developing roller 103 comes into contact with the photosensitive drum 101, the force applying member 111 moves in the second direction W2 and separates from the force receiving member 171. After the movement of the force applying member 111, a gap is provided between the force applying member 111 and the force receiving member 171. In addition, when the force applying member 111 moves in the second direction W2 and separates from the force receiving member 171, the force receiving member 171 slightly rotates in a direction opposite to the second rotating direction R2 due to a biasing force of a biasing member that biases the force receiving member 171 upward and the like. Furthermore, while the holding member 170 also attempts to move in a direction opposite to the first rotating direction R1 due to the biasing force of the tension spring 172 and the like, the rotation of the holding member 170 is restricted by the cartridge cover member 123 as shown in FIG. 13C. Due to such a configuration, even if the force applying member 111 is separated from the force receiving member 171, the holding member 170 is prevented from inadvertently rotating from the second position to the first position. Note that during an image forming operation by the image forming apparatus 1, the holding member 170, the force receiving member 171, and the force applying member 111 are in the positions shown in FIG. 13C. At this point, the holding member 170 and the force receiving member 171 are separated from each other.

On the other hand, when the developing unit 150 moves from the contact position to the separation position and the process cartridge 100 makes a transition from the developing contact state to the developing separation state, the force applying member 111 moves in the second direction W2 and presses the force receiving member 171. Due to a force receiving portion 171g formed on an opposite side to the force receiving portion 171b of the force receiving member 171 being pressed in the second direction W2 by the force applying portion 111a, the force receiving member 171 moves in a direction opposite to the second rotating direction R2. As a result, the developing unit 150 swings in a direction of separation from the drum unit 120 together with the developing frame body supporting the force receiving member 171 and the developing roller 103 separates from the photosensitive drum 101. In addition, with the movement of the force receiving member 171, the holding member 170 rotates from the second position to the first position in a direction opposite to the first rotating direction R1 due to the biasing force of the tension spring 172. Subsequently, when the force applying member 111 moves in the first direction W1 and separates from the force receiving member 171, the developing unit 150 swings toward the drum unit 120 due to the biasing force of the biasing configuration and the spacer member 170b comes into contact with the contacted portion 123c. In addition, as the front door 10 is opened and the force receiving member 171 is released from the state of being pressed by the linking mechanism which operates in conjunction with opening/closing operations of the front door 10, the force receiving member 171 moves upward from the fourth position toward the fifth position.

### Developing Contact Suppression Configuration in Individual Cartridge State

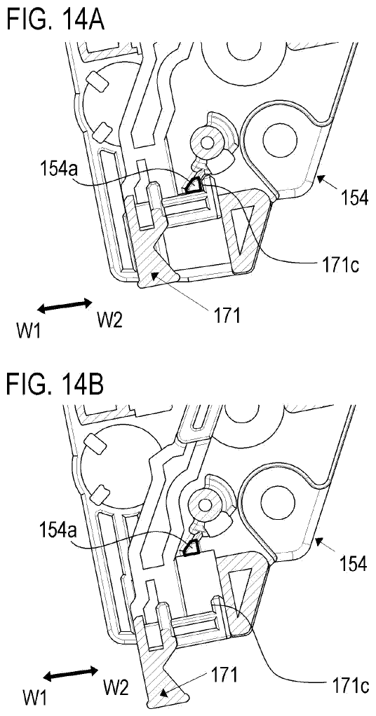

As described above, in the process cartridge 100, switching between the developing contact state and the developing separation state is performed by a movement (rotation) of the force receiving member 171. Therefore, for example, when a user performs an operation to attach or remove the process cartridge 100, there is a risk that the process cartridge 100 is mistakenly switched from the developing separation state to the developing contact state due to a movement of the force receiving member 171 when inadvertently pressed or the like. In consideration thereof, the process cartridge 100 is provided with a developing contact suppression configuration which prevents the user from inadvertently releasing the developing separation state in a state where the process cartridge 100 is not mounted to the image forming apparatus 1 (individual state). Therefore, the developing contact suppression configuration will be described with reference to FIGS. 14A and 14B. FIGS. 14A and 14B are explanatory diagrams of the developing contact suppression configuration.

The developing unit 150 includes a projected portion 154a as a restricting portion which restricts the force receiving member 171 from rotating in the second rotating direction R2 so as to move the holding member 170 from the first position to the second position. In the first embodiment, the projected portion 154a is provided on the bearing 154 on the non-driven side and protrudes toward the side of the force receiving member 171 in the rotational axis direction of the developing roller 103. In other words, the bearing 154 can also be described as being a restricting member which includes the projected portion 154a and which restricts rotation of the force receiving member 171. In addition, the force receiving member 171 is provided with a restricted portion 171c which engages with the projected portion 154a.

FIG. 14A shows the process cartridge 100 in a state of not being mounted to the apparatus main body 2. At this point, the force receiving member 171 is at the fifth position. When the force receiving member 171 is at the fifth position, the restricted portion 171c is positioned on a downstream side of the projected portion 154a in the second rotating direction R2 (first direction W1) and is at a position which overlaps with the projected portion 154a when viewed in the first direction W1. In other words, since the projected portion 154a is positioned on a rotation trajectory of the restricted portion 171c, when the force receiving member 171 attempts to move in the second rotating direction R2, the restricted portion 171c comes into contact with the projected portion 154a and the projected portion 154a restricts the rotation of the force receiving member 171 in the second rotating direction R2. In this manner, when the force receiving member 171 is at the fifth position, rotation in the second rotating direction R2 is restricted by the projected portion 154a.

FIG. 14B shows the process cartridge 100 in a state of being mounted to the apparatus main body 2 and the front door 10 is closed. At this point, the force receiving member 171 is pressed from above and moves to the fourth position below the fifth position. When the force receiving member 171 is at the fourth position, the restricted portion 171c is positioned below the projected portion 154a and is at a position which does not overlap with the projected portion 154a when viewed in the first direction W1. In other words, since the projected portion 154a is positioned outside the rotation trajectory of the restricted portion 171c, even if the force receiving member 171 moves in the second rotating direction R2, the restricted portion 171c does not come into contact with the projected portion 154a and the projected portion 154a does not restrict the rotation of the force receiving member 171 in the second rotating direction R2. As described above, the force receiving member 171 moves from the fifth position to the fourth position in conjunction with a closing operation of the front door 10.

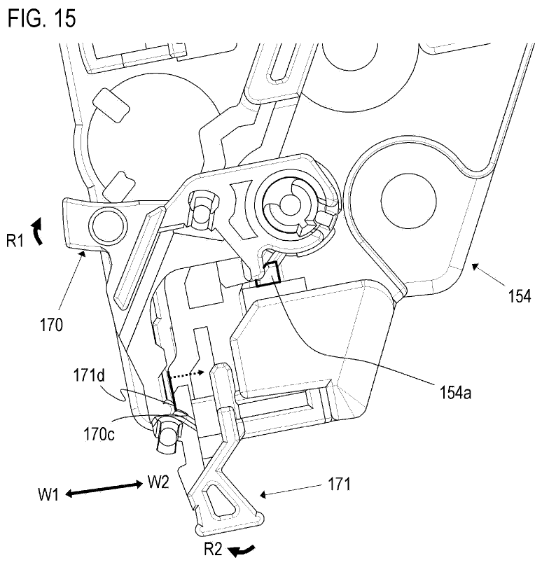

FIG. 15 is an explanatory diagram of an arrangement relationship between the projected portion 154a and the force receiving member 171. When the force receiving member 171 is positioned at the fourth position and the holding member 170 is positioned at the first position, a first engagement surface 171d of the force receiving member 171 comes into contact with a pressed surface 170c of the holding member 170. The first engagement surface 171d is a surface facing a downstream side in the second rotating direction R2 and the pressed surface 170c is a surface facing a upstream side in the first rotating direction R1. As shown in FIG. 15, the projected portion 154a is positioned on the upstream side in the second rotating direction R2 with respect to the first engagement surface 171d and the pressed surface 170c or, in other words, a contact portion between the force receiving member 171 and the holding member 170. Due to such an arrangement relationship, in a state where the process cartridge 100 is mounted to the image forming apparatus 1, the rotation in the first rotating direction R1 of the holding member 170 and the rotation in the second rotating direction R2 of the force receiving member 171 are not obstructed by the projected portion 154a.

As described so far, the force receiving member 171 is configured to be translatable to the fourth and fifth positions and rotatable at the fourth position. In addition, when the force receiving member 171 is at the fourth position, the force receiving member 171 presses the holding member 170 in the first rotating direction R1 by rotating in the second rotating direction R2. Furthermore, when the force receiving member 171 is at the fifth position, the restricted portion 171c comes into contact with the projected portion 154a when the force receiving member 171 rotates in the second rotating direction R2. Due to such a configuration, since the force receiving member 171 is at the fifth position when the process cartridge 100 is removed from the apparatus main body 2, the developing separation state of the process cartridge 100 is maintained. On the other hand, when the process cartridge 100 is mounted to the apparatus main body 2 and the force receiving member 171 moves from the fifth position to the fourth position, the force receiving member 171 enters a rotatable state. In addition, due to the rotation of the force receiving member 171 and the force receiving member 171 rotating the holding member 170, the contacting/separating operation of the photosensitive drum 101 and the developing roller 103 in the process cartridge 100 is executed.

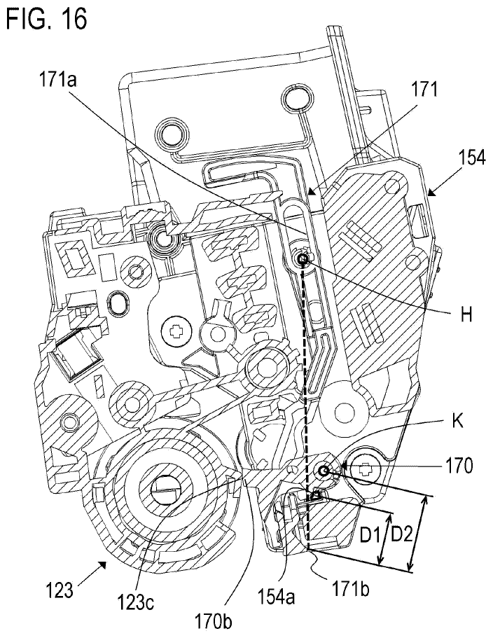

FIG. 16 is an explanatory diagram of an arrangement position of the projected portion 154a. When the force receiving member 171 is at the fifth position, the projected portion 154a is provided at a position which is closer to the force receiving portion 171b than to the rotation center K of the holding member 170 in a direction connecting the rotation center H of the force receiving member 171 and the force receiving portion 171b. In other words, when the force receiving member 171 is at the fifth position, a distance D1 from the projected portion 154a to the force receiving portion 171b is shorter than a distance D2 from the rotation center K of the holding member 170 to the force receiving portion 171b when viewed in the longitudinal direction of the developing unit 150. When a distance from the force receiving portion 171b to the projected portion 154a or the restricted portion 171c is long, an amount of deformation of the force receiving member 171 increases if the force receiving portion 171b receives a force from the force applying member 111 in a state where the restricted portion 171c is in contact with the projected portion 154a. On the other hand, by reducing the distance from the projected portion 154a (restricted portion 171c) to the force receiving portion 171b, deformation of the force receiving member 171 when the force receiving portion 171b receives a force can be suppressed as compared to a case where the distance is long. Therefore, since the amount of rotation (distance) in the first rotating direction R1 of the holding member 170 due to deformation of the force receiving member 171 can be reduced, a release of the developing separation state of the process cartridge 100 can be more reliably suppressed.

Due to the configuration described above, in the first embodiment, the position of the force receiving member 171 differs between when the process cartridge 100 is in the individual state and a state where the process cartridge 100 is mounted to the apparatus main body 2. In addition, the rotation of the force receiving member 171 in the second rotating direction R2 is restricted when the process cartridge 100 is in the individual state but the rotation of the force receiving member 171 in the second rotating direction R2 is not restricted in a state where the process cartridge 100 is mounted to the apparatus main body 2. Due to such a configuration, when the process cartridge 100 is in the individual state, a situation where the force receiving member 171 is moved by mistake and the process cartridge 100 makes a transition from the developing separation state to the developing contact state can be suppressed. In addition, in a state where the process cartridge 100 is mounted to the apparatus main body 2, the force receiving member 171 can be moved as intended and the developing separation state and the developing contact state of the process cartridge 100 can be switched.

### Switching Configuration of Engagement Position Between Holding Member and Force Receiving Member

As described above, in the first embodiment, the developing unit 150 swings from the separation position to the contact position due to the holding member 170 moving from the first position to the second position. However, when a rotation range of the holding member 170 is designed from the first position to the second position, depending on dimensional variability or deformation of components, there is a risk that the holding member 170 does not rotate to the second position as designed and a development contact/separation operation is not performed properly. On the other hand, when the rotation range of the holding member 170 is excessively expanded, since a movement range of the force applying member 111 expands, there is a risk that the force applying member 111 may interfere with other members. In addition, when the movement range of the force applying member 111 is wide, since the force applying member 111 must be arranged separated from the drum unit 120 and the like, there is a risk that the size of the image forming apparatus 1 may have to be increased. In consideration thereof, in the first embodiment, the holding member 170 and the force receiving member 171 are configured so that a development contact/separation operation can be executed more reliably while suppressing an increase in the size of the image forming apparatus 1. Hereinafter, the configuration of the holding member 170 and the force receiving member 171 for solving the problem described above will be described.

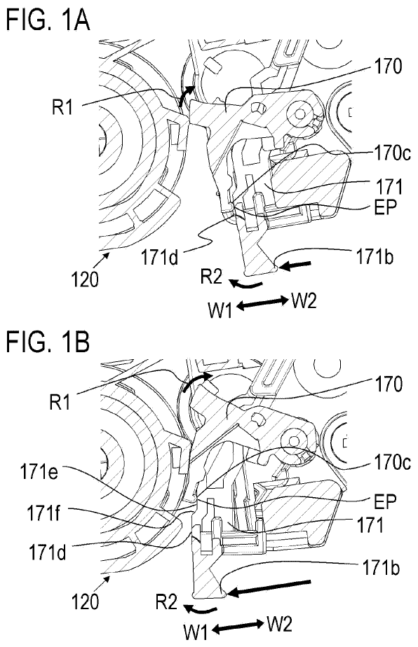

A switching configuration of an engagement position EP between the holding member 170 and the force receiving member 171 will be described with reference to FIGS. 1A and 1B. FIGS. 1A and 1B are explanatory diagrams of a switching configuration of the engagement position EP between the holding member 170 and the force receiving member 171. The engagement position EP refers to a position where the holding member 170 and the force receiving member 171 are engaged with each other and is a contact location between the members.

As shown in FIG. 1B, the force receiving member 171 includes the first engagement surface 171d as a first surface, a second engagement surface 171e as a second surface, and an inclined surface 171f as the connecting surface, as a surface engaging with the holding member 170. At least when the developing unit 150 is at the separation position, the first engagement surface 171d, the second engagement surface 171e, and the inclined surface 171f all face the side of the first direction W1. More specifically, in a state where the holding member 170 is at the first position, the first engagement surface 171d and the second engagement surface 171e are approximately orthogonal to the first direction W1.

The first engagement surface 171d is formed at a tip portion (end on the side of the force receiving portion 171b) of the force receiving member 171. The second engagement surface 171e is formed on the side of the supported portion 171a (the side of the rotation center of the force receiving member 171) with respect to the first engagement surface 171d and more to the side of the second direction W2 than the first engagement surface 171d. In other words, the second engagement surface 171e is formed so as to be depressed in an opposite direction to the direction faced by the first engagement surface 171d with respect to the first engagement surface 171d. In addition, the second engagement surface 171e is approximately parallel to the first engagement surface 171d. The inclined surface 171f is a surface which connects the first engagement surface 171d and the second engagement surface 171e and is formed inclined with respect to the first engagement surface 171d and the second engagement surface 171e.

FIG. 1A shows the holding member 170 in the process of making a transition from the first position to the second position. When the holding member 170 is at the first position, the pressed surface 170c of the holding member 170 comes into contact with the first engagement surface 171d of the force receiving member 171. At this point, the engagement position EP between the holding member 170 and the force receiving member 171 is on the first engagement surface 171d.

As the force receiving member 171 rotates in the second rotating direction R2, the holding member 170 rotates in the first rotating direction R1 and the pressed surface 170c gradually moves in an upward direction. In addition, when the holding member 170 reaches the second position, the pressed surface 170c comes into contact with the inclined surface 171f. At this point, the engagement position EP between the holding member 170 and the force receiving member 171 is on the inclined surface 171f. Note that the engagement position EP can also be configured to be on the first engagement surface 171d or on the second engagement surface 171e when the holding member 170 is positioned at the second position.

In addition, in the first embodiment, the holding member 170 is configured to be further rotatable in the first rotating direction R1 from the second position. A position of the holding member 170 when the holding member 170 is pushed by the force receiving member 171 and further moves in the first rotating direction R1 from the second position and where the holding member 170 comes into contact with the drum unit 120 (photosensitive unit) is referred to as a third position. In other words, the holding member 170 is configured to be rotatable to the first position, the second position, and the third position. When the holding member 170 is at the third position, the developing roller 103 is in contact with the photosensitive drum 101 and the process cartridge 100 is in the developing contact state.

Due to the holding member 170 being configured to be rotatable in the first rotating direction R1 from the second position to the third position, even when there is variability in dimensions of the components or when the components deform, the process cartridge 100 can be reliably switched from the developing separation state to the developing contact state. In this manner, the process cartridge 100 is configured to be capable of more reliably switching from the developing separation state to the developing contact state in consideration of dimensional variability and deformation of the components.

FIG. 1B shows a state where the holding member 170 has moved to the third position. Due to the holding member 170 at the second position further rotating in the first rotating direction R1, the pressed surface 170c moves from being on the inclined surface 171f to being on the second engagement surface 171e. In addition, when the holding member 170 is at the third position, the pressed surface 170c of the holding member 170 comes into contact with the second engagement surface 171e of the force receiving member 171. At this point, the engagement position EP between the holding member 170 and the force receiving member 171 is on the second engagement surface 171e. In addition, when the holding member 170 is at the third position, the holding member 170 comes into contact with the cartridge cover member 123 of the drum unit 120. Therefore, excessive rotation in the second rotating direction R2 by the holding member 170 beyond the third position is restricted by the drum unit 120.

As described above, in the first embodiment, the engagement position EP moves upward on the first engagement surface 171d and reaches the inclined surface 171f in the process of the holding member 170 moving from the first position to the second position. In addition, the engagement position EP moves from being on the inclined surface 171f to being on the second engagement surface 171e in the process of the holding member 170 moving from the second position to the third position. Therefore, a configuration is adopted in which, in the process of the holding member 170 moving from the first position to the third position, a contact object of the pressed surface 170c is switched from the first engagement surface 171d to the second engagement surface 171e which is more depressed than the first engagement surface 171d.

Due to switching of the engagement position EP between the force receiving member 171 and the holding member 170 from being on the first engagement surface 171d to being on the second engagement surface 171e, a movement amount (rotation amount) of the holding member 170 with respect to a movement amount of the force receiving member 171 can be reduced. In order to rotate the holding member 170 in the first rotating direction R1, the force applying member 111 must be moved in the first direction W1 and the force receiving member 171 must be rotated in the second rotating direction R2. However, according to the configuration described above, since the rotation amount of the holding member 170 decreases, a distance by which the force applying member 111 moves in the first direction W1 or, in other words, in a direction approaching the drum unit 120 can be reduced. Therefore, the force applying member 111 can be arranged at a position closer to the drum unit 120 and the size of the image forming apparatus 1 can be downsized. In other words, even in a configuration in which the holding member 170 is rotatable from the second position to the third position, an arrangement space (movement range) of the force applying member 111 can be reduced while preventing unintentional contact between the holding member 170 and the drum unit 120. The size of the image forming apparatus 1 can then be downsized by the amount of reduction of the arrangement space of the force applying member 111.

Furthermore, as described above, the first engagement surface 171d and the second engagement surface 171e are connected by the inclined surface 171f. The inclined surface 171f is formed so that an angle with the second engagement surface 171e is an obtuse angle. Due to such a configuration, when the holding member 170 returns from the third position to the first position, the holding member 170 is guided by the inclined surface 171f and returns from the position where the holding member 170 comes into contact with the second engagement surface 171e to the position where the holding member 170 comes into contact with the first engagement surface 171d without being caught.

Note that while the contact/separation mechanism and the developing contact suppression configuration on the non-driven side of the process cartridge 100 have been described above, the driven side is also provided with a similar mechanism and a similar configuration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-057812, filed on Mar. 29, 2024, which is hereby incorporated by reference herein in its entirety.

What is claimed is:

1. A cartridge configured to be attachable to and detachable from an image forming apparatus, the cartridge comprising:
a first unit including a photosensitive member;
a second unit including a developing member which develops an electrostatic latent image formed on the photosensitive member, the second unit being configured to be swingable with respect to the first unit between a contact position where the developing member comes into contact with the photosensitive member and a separation position where the developing member separates from the photosensitive member;
a rotating member configured to be rotatable to a first position, a second position, and a third position, the first position being a position for holding the second unit at the separation position against a biasing force which biases the second unit at the separation position toward the contact position, the second position being a position for holding the second unit at the contact position and being a position rotated in a first rotating direction from the first position, and the third position being a position further rotated in the first rotating direction from the second position; and
a pressing member configured to be capable of pressing the rotating member in the first rotating direction, the pressing member includes a first surface which comes into contact with the rotating member at the first position and a second surface which is depressed in an opposite direction to a direction faced by the first surface with respect to the first surface and which can come into contact with the rotating member in a case where the rotating member is positioned at the third position.

2. The cartridge according to claim 1,
wherein the pressing member has a connecting surface which connects the first surface and the second surface to each other and of which an angle with the second surface is an obtuse angle.

3. The cartridge according to claim 2,
wherein the connecting surface of the pressing member comes into contact with the rotating member positioned at the second position.

4. The cartridge according to claim 1,
wherein the second surface is formed on a side closer to a rotation center of the pressing member than the first surface.

5. The cartridge according to claim 1,
wherein the second unit includes a developing frame body which supports the developing member, the rotating member, and the pressing member.

6. The cartridge according to claim 1,
wherein the pressing member is configured to be rotatable in a second rotating direction around a rotation axis parallel to a rotation axis of the rotating member, and
wherein in a case where the rotating member is at the first position, a distance from a contact portion between the rotating member and the pressing member to a rotation center of the pressing member is greater than a distance from the contact portion to a rotation center of the rotating member.

7. The cartridge according to claim 6,
wherein the pressing member includes a force receiving portion which receives a force for rotating in the second rotating direction, and
wherein in a case where the rotating member is at the first position, a distance from the force receiving portion to the rotation center of the pressing member is greater than the distance from the contact portion between the rotating member and the pressing member to the rotation center of the pressing member.

8. An image forming apparatus, comprising:
an apparatus main body; and
a cartridge attachable to and detachable from the apparatus main body, the cartridge including:
a first unit including a photosensitive member;
a second unit including a developing member which develops an electrostatic latent image formed on the photosensitive member, the second unit being configured to be swingable with respect to the first unit between a contact position where the developing member comes into contact with the photosensitive member and a separation position where the developing member separates from the photosensitive member;
a rotating member configured to be rotatable to a first position, a second position, and a third position, the first position being a position for holding the second unit at the separation position against a biasing force which biases the second unit at the separation position toward the contact position, the second position being a position for holding the second unit at the contact position and being a position rotated in a first rotating direction from the first position, and the third position being a position further rotated in the first rotating direction from the second position; and
a pressing member configured to be capable of pressing the rotating member in the first rotating direction, the pressing member includes a first surface which comes into contact with the rotating member at the first position and a second surface which is depressed in an opposite direction to a direction faced by the first surface with respect to the first surface and which can come into contact with the rotating member in a case where the rotating member is positioned at the third position.

9. The image forming apparatus according to claim 8,
wherein the pressing member is configured to be rotatable in a second rotating direction around a rotation axis parallel to a rotation axis of the rotating member,
wherein in a case where the rotating member is at the first position, a distance from a contact portion between the rotating member and the pressing member to a rotation center of the pressing member is greater than a distance from the contact portion to a rotation center of the rotating member,
wherein the pressing member includes a force receiving portion which receives a force for rotating in the second rotating direction,
wherein in a case where the rotating member is at the first position, a distance from the force receiving portion to the rotation center of the pressing member is greater than the distance from the contact portion between the rotating member and the pressing member to the rotation center of the pressing member, and
wherein the image forming apparatus further comprises a force applying member which applies a force to the force receiving portion.
